(19) United States
(12) Patent Application Publication
(10) Pub. No.: US 2024/0198247 A1
(43) Pub. Date: Jun. 20, 2024

(54) Construction Systems and Methods for Making Constructions

(71) Applicant: WoodMee Holding ApS, Struer (DK)

(72) Inventor: Jesper Elling, Struer (DK)

(21) Appl. No.: 18/588,374

(22) Filed: Feb. 27, 2024

Related U.S. Application Data
(63) Continuation of application No. PCT/DK22/50176, filed on Aug. 30, 2022.

(30) Foreign Application Priority Data
Sep. 2, 2021 (DK) PA 2021 00853

(51) Int. Cl. A63H 33/10

(52) U.S. Cl. CPC A63H 33/107; A63H 33/106

(57) ABSTRACT

A construction system includes at least two building elements provided with one or more cylindrical holes and one or more connection pins having a first end, a second end and a longitudinal axis. The connection pins are configured to be detachably inserted into the holes and hereby connect two adjacent building elements. The connection pins are provided with a first notch extending along the longitudinal axis and a second notch extending along the longitudinal axis, wherein the first notch extends from the first end to a position between the first end and the second end, wherein the second notch extends from the second end to a position between the first end and the second end. The width of the connection pins is larger than the width of the cylindrical holes.

### CROSS-REFERENCE TO RELATED APPLICATIONS

This application is a continuation under 35 U.S.C. 111 of International Patent Application No. PCT/DK2022/050176, filed Aug. 30, 2022, which claims the benefit of and priority to Danish Application No. PA 2021 00853, filed Sep. 2, 2021, each of which is hereby incorporated by reference in its entirety.

### FIELD OF INVENTION

The present disclosure relates to construction systems comprising at least two building elements provided with one or more cylindrical holes and at least one connection pin. The disclosure also relates to methods for making such systems.

### BACKGROUND

JP 3210548 U discloses a wooden cylindrical joint rod for connecting blocks with holes. The joint rod is configured to be into a through hole and be moved the entire way through the hole.

The wooden joint rod, however, is expanded when exposed to moisture. Accordingly, the outer diameter of the joint rod needs to be produced in such a manner that the joint rod can be inserted into a hole even when the joint rod has been expanded. Therefore, the joint rod is not firmly attached to the hole when the joint rod is dry.

Moreover, the joint rod is inserted all the way through a through hole. This introduces the risk for permanent damage of the joint rod.

U.S. Pat. No. 4,461,116A discloses a connecting member comprising an elastically deformable, tubular plug slitted at the ends for interconnecting pairs of building components. The building components have coupling holes to receive the ends of the connecting member. There are apertures in the plug wall between the slits and the plug wall is formed with lengthwise extending clamping wedges between the apertures. The clamping wedges have inclined faces which slope towards the ends of the connecting member and cause the connecting member to be compressed at the center and be expanded at the ends when it is pressed into a pair of co-axial holes in adjacent building components. The connecting member is designed to be manufactured of plastic and thus the plug can deform slightly when the wedges engage with a coupling hole. When the plug is made of metal, however, the wedges will damage the hole if the building components are made of softer materials. Accordingly, there is need for an alternative plug if the plug is made of a harder material (e.g. metal) than the building components (e.g. made of wood).

U.S. Pat. No. 2,170,771A discloses toy construction elements having in combination a hub member having an axial opening therethrough and circumferentially spaced sockets in its periphery, said opening and sockets being of the same diameter, two series of rods, the rods of one series being of a diameter substantially the same as the diameters of the opening and diameters of the central opening and sockets of the hub member, a flanged bushing having a bore of a diameter to tightly receive a rod of smaller diameter, said bushing being of a major diameter to snugly engage within the opening or sockets of the hub member. The solution is, however, not suitable for attaching hub members/blocks a non-zero distance from each other. Accordingly, it would be desirable to have an alternative solution that makes it possible to attach hub members/blocks a non-zero distance from each other.

Accordingly, it would be desirable to have an alternative which reduces or even eliminates the above mentioned disadvantages of the prior art.

### BRIEF DESCRIPTION

In an embodiment, a construction system comprises:
a) at least two building elements provided with one or more cylindrical holes and
b) one or more connection pins having a first end, a second end and a longitudinal axis, wherein the connection pins are configured to be detachably inserted into the holes and hereby connect two adjacent building elements, wherein the connection pins are provided with a first notch extending along the longitudinal axis and a second notch extending along the longitudinal axis, wherein the first notch extends from the first end to a first position between the first end and the second end, wherein the second notch extends from the second end to a second position between the first end and the second end,
   wherein the width of the connection pins is larger than the width of the cylindrical holes,
   wherein the connection pin has a cylindrical outer surface,
   wherein:
a) the width of the connection pins is 2-10% larger than the width of the cylindrical holes;
b) the first notch and the second notch are basically plate-shaped and extend perpendicular to each other; and
c) a depth L₃ of the notch is larger than two thirds of a length L₄ of the connection pin.

Hereby, it is possible to provide a reliable construction system.

The building elements may have any suitable geometry and size.

The building elements are provided with one or more cylindrical holes.

The connection pin has a first end, a second end and a longitudinal axis.

Each connection pin is configured to be detachably inserted into the holes and hereby connect two adjacent building elements.

Each connection pin is provided with a first notch extending along the longitudinal axis and a second notch extending along the longitudinal axis.

The first notch extends from the first end to a first position between the first end and the second end.

The second notch extends from the second end to a second position between the first end and the second end. Hereby, an outwardly directed force will be provided from the pin to the wall of the hole. Accordingly, the pin will be firmly attached to the hole. At the same time, the notch will provide flexibility (the width of the pin can be reduced by compressing the distal end of the pin). This flexibility allows the pin to be:
A) detachably inserted into the hole; and
B) removed from the hole in an easy manner.

The width of each connection pin is larger than the width of the cylindrical holes.

The width of the connection pins is 2-10% larger than the width of the cylindrical holes.

In an embodiment, the width of the connection pins is 3-8% larger than the width of the cylindrical holes.

In an embodiment, the width of the connection pins is 4-7% larger than the width of the cylindrical holes.

In an embodiment, the width of the connection pins is 5% larger than the width of the cylindrical holes.

In an embodiment, the width of the end portions of the connection pins is 4.2 mm, wherein the width of the cylindrical holes is 4.0 mm.

In an embodiment, the width of the end portions of the connection pins is 4.2 mm, wherein the width of the cylindrical holes is 4.1 mm.

In an embodiment, the width of the end portions of the connection pins is 4.2 mm, wherein the width of the cylindrical holes is 3.9 mm.

In an embodiment, the width of the end portions of the connection pins is 4.2 mm, wherein the width of the cylindrical holes is 3.9-4.1 mm.

In an embodiment, the depth of the holes corresponds to half the length of the pin.

In an embodiment, at least some of the holes are blind holes.

In an embodiment, all holes of at least one of the building elements are blind holes.

The first notch comprises a distal portion composed of two parallel surfaces.

The surfaces of the distal portion of the first notch extend perpendicular to the surfaces of the distal portion of the second notch.

In an embodiment, the construction system comprises at least one box-shaped building element.

In an embodiment, the construction system comprises at least one spherical building element.

In an embodiment, the construction system comprises at least one cylindrical building element.

In an embodiment, the construction system comprises at least one building element shaped as a hose. The hose comprises a hole provided in each end. Accordingly, the hose can be detachably attached to connection pins.

In an embodiment, the construction system comprises at least one plate designed to be detachably inserted into one of the notches of one of the connection pins and hereby be detachably attached to the connection pins.

In an embodiment, the construction system comprises at least one extension pin that is longer than the connection pin, wherein the end portions of the extension pin correspond to the end portions of the connection pin.

In an embodiment, the construction system comprises a pivot configured to receive an end portion of the connection pin.

In an embodiment, the construction system comprises at least one wheel comprising a rotatably mounted joint configured to receive an end portion of the connection pin.

In an embodiment, the connection pin is made of metal.

In an embodiment, the connection pin is made of steel.

In an embodiment, the connection pin is made of stainless steel.

In an embodiment, the connection pin is made of ceramics.

In an embodiment, the connection pin is made of carbon fiber.

In an embodiment, the connection pin is made of rubber.

In an embodiment, the connection pin is made of rubber composite.

In an embodiment, the connection pin is made of plastic.

In an embodiment, the building elements are made of wood.

In one embodiment, the building elements are made of plastic.

In an embodiment, at least some of the building elements are made of ceramics.

In an embodiment, at least some of the building elements are made of carbon fiber.

In an embodiment, at least some of the building elements are made of stone.

In an embodiment, at least some of the building elements are made of amber.

In an embodiment, at least some of the building elements are made of rubber.

In an embodiment, at least some of the building elements are made of rubber composite.

In an embodiment, a method for building a construction system comprises:
a) at least two building elements provided with one or more cylindrical holes; and
b) at least one connection pin having a first end, a second end and a longitudinal axis, wherein the connection pin is configured to be detachably inserted into the holes and hereby connect two adjacent building elements, wherein the connection pins are provided with a first notch extending along the longitudinal axis and a second notch extending along the longitudinal axis, wherein the first notch extends from the first end to a first position between the first end and the second end, wherein the second notch extends from the second end to a second position between the first end and the second end,
   wherein the method comprises the step of:
inserting the first end of the connection pin into a hole of a first building element and inserting the second end of the connection pin into a hole of a second building element and hereby detachably attaching the first building element and the second building element,
   wherein the width of the connection pins is larger than the width of the cylindrical holes,
   wherein the connection pin has a cylindrical outer surface,
   wherein:
a) the width of the connection pins is 2-10% larger than the width of the cylindrical holes;
b) the first notch and the second notch are basically plate-shaped and extend perpendicular to each other; and
c) a depth L₃ of the notch is larger than two thirds of a length L₄ of the connection pin.

Hereby, it is possible to provide a reliable method that reduces or even eliminates the above-mentioned disadvantages of the prior art.

By having a pin width that is larger than the width of the cylindrical holes, an outwardly directed force will be provided from the pin to the wall of the hole. Accordingly, the pin will be firmly attached to the hole. At the same time, the notch will provide flexibility (the width of the pin can be reduced by compressing the distal end of the pin). This flexibility allows the pin to be:
A) detachably inserted into the hole; and
B) removed from the hole in an easy manner.

The width of the connection pins is 2-10% larger than the width of the cylindrical holes.

In an embodiment, the width of the connection pins is 3-8% larger than the width of the cylindrical holes.

In an embodiment, the width of the connection pins is 4-7% larger than the width of the cylindrical holes.

In an embodiment, the width of the connection pins is 5% larger than the width of the cylindrical holes.

In an embodiment, the depth of the holes corresponds to half the length of the pin

In an embodiment, the construction system comprises at least one box-shaped building element.

In an embodiment, the construction system comprises at least one spherical building element.

In an embodiment, the construction system comprises at least one cylindrical building element.

In an embodiment, the construction system comprises at least one building element shaped as a hose.

In an embodiment, the construction system comprises at least one plate designed to be detachably inserted into one of the notches of one of the connection pins and hereby be detachably attached to the connection pins.

In an embodiment, the construction system comprises at least one extension pin that is longer than the connection pin, wherein the end portions of the extension pin correspond to the end portions of the connection pin.

In an embodiment, the construction system comprises at least one wheel comprising a rotatably mounted joint configured to receive an end portion of the connection pin.

### BRIEF DESCRIPTION OF THE DRAWINGS

Systems and methods will become more fully understood from the detailed description given herein below. The accompanying drawings are given by way of illustration only, and thus, they are not limitative of the systems and methods. In the accompanying drawings:

FIG. 1A shows a cross-sectional view of a construction system according to an embodiment;

FIG. 1B shows a side view of a connection pin of a construction system according to an embodiment;

FIG. 2A shows a side view a connection pin of a construction system according to an embodiment;

FIG. 2B shows an end view of a connection pin of a construction system according to an embodiment;

FIG. 2C shows another end view of the connection pin shown in FIG. 2B;

FIG. 3A shows a perspective view of a connection pin of a construction system according to an embodiment;

FIG. 3B shows a side view of the connection pin shown in FIG. 3A;

FIG. 3C shows the connection pin shown in FIG. 3A and FIG. 3B arranged in a position from which the connection pin is arranged to be inserted into a hole;

FIG. 4A shows an end view of a connection pin of a construction system according to an embodiment;

FIG. 4B shows another end view of the connection pin shown in FIG. 4A;

FIG. 4C shows a perspective view of the connection pin shown in FIG. 4A and FIG. 4B;

FIG. 5A shows a building block of a construction system according to an embodiment;

FIG. 5B shows another building block of a construction system according to an embodiment;

FIG. 5C shows a further building block of a construction system according to an embodiment;

FIG. 5D shows two building blocks of a construction system according to an embodiment;

FIG. 6A shows two building blocks of a construction system according to an embodiment being attached to each other by a connection pin according to an embodiment;

FIG. 6B shows the two building blocks shown in FIG. 6A in an assembled configuration;

FIG. 7A shows three building blocks of a construction system according to an embodiment being attached to each other by pins according to an embodiment;

FIG. 7B shows the three building blocks shown in FIG. 7A in an assembled configuration;

FIG. 8A shows two building elements of a construction system according to an embodiment in a configuration in which the building elements have been attached to each other by a connection pin according to an embodiment;

FIG. 8B shows another view of the construction system shown in FIG. 8A;

FIG. 8C shows two building blocks of a construction system according to an embodiment in a configuration in which the building blocks have been attached to a hose by connection pins according to an embodiment;

FIG. 9A shows a side view of a connection pin being inserted into a building element of a construction system according to an embodiment;

FIG. 9B shows a top view of a building element according to an embodiment comprising a ball bearing; and

FIG. 9C shows a cross-sectional view of the building element shown in FIG. 9B.

### DETAILED DESCRIPTION

As used herein, “plate-shaped” describes an object having a top surface, a bottom surface oriented parallel to the top surface, and a plurality of edges connecting the top surface and the bottom surface. A thickness of the plate-shaped object, defined as the distance between the top surface and the bottom surface, is much smaller than a length or width of the top surface or the bottom surface.

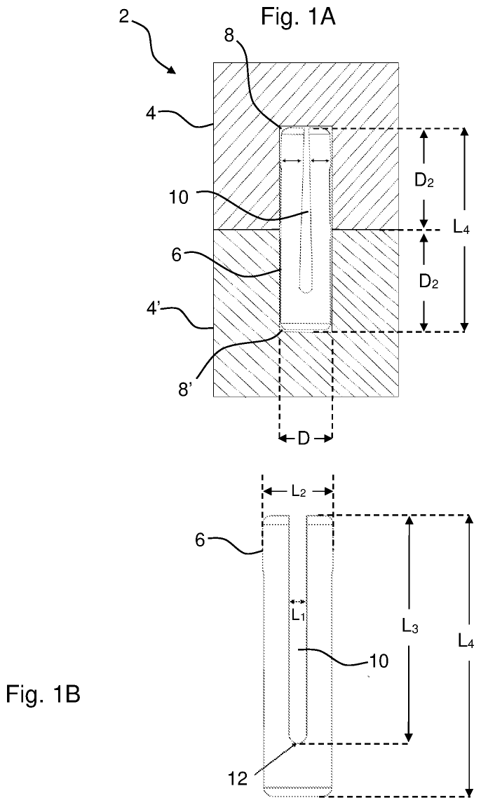

FIG. 1A illustrates a cross-sectional view of a construction system 2 according to an embodiment. The construction system 2 comprises a first building block 4 and a second building block 4′. The first building block 4 comprises a blind hole 8. Likewise, the second building block 4′ comprises a blind hole 8′. The construction system 2 comprises a connection pin 6 provided with a notch 10 extending along the longitudinal axis of the connection pin 6.

The hole 8′ of the second building block 4′ is cylindrical and has a width D. The hole 8 of the first building block 4 is cylindrical and has a width D. The distal portion of the connection pin 6 has been compressed in such a manner that the width of the distal portion of the connection pin 6 corresponds to the width D of the hole 8. It can be seen that the distal portion of the notch 10 has a smaller width than the proximal portion of the notch 10 because the distal portion of the connection pin 6 has been pressed together.

It can be seen that the connection pin 6 has a length L₄. The depth D₂ of the first building block 4 corresponds to the depth D₂ of the second building block 4′. The depth D₂ corresponds to one half of the length L₄.

FIG. 1B illustrates a side view of a connection pin 6 of a construction system according to an embodiment. The connection pin 6 comprises a notch 10 extending along the longitudinal axis of the connection pin 6. The width L₁ of the notch 10 is smaller than a third of the width L₂ of the connection pin 6.

It can be seen that the depth L₃ of the notch 10 is larger than two thirds of the length L₄ of the connection pin 6. The bottom portion 12 of the notch 10 is concave.

The notch 10 makes the connection pin 6 flexible. The distal portion of the connection pin 6 can be compressed so that the width L₂ is reduced as seen in FIG. 1A.

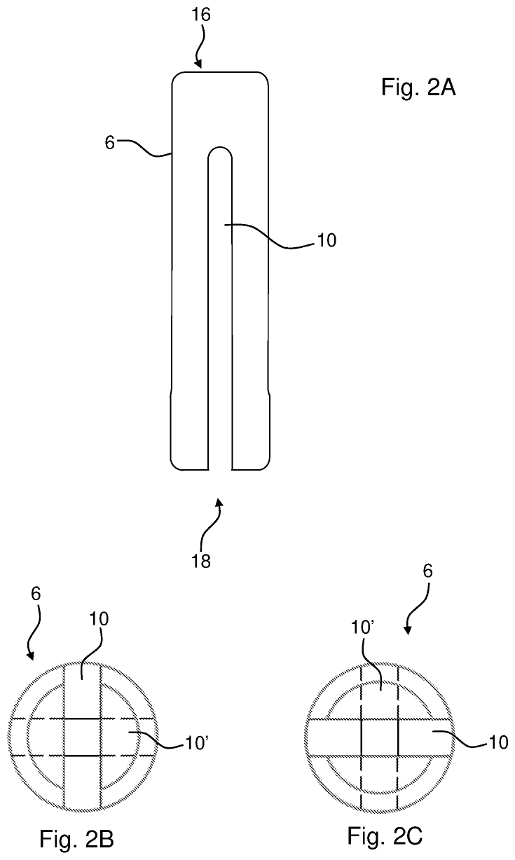

FIG. 2A illustrates a side view connection pin 6 of a construction system according to an embodiment. The connection pin 6 corresponds to the one shown in and explained with reference to FIG. 1A and FIG. 1B.

The connection pin 6 comprises a first end 16 and a second end 18. The first end 16 comprises a closed portion, while the second end 18 comprises an open portion.

FIG. 2B illustrates an end view of connection pin 6 of a construction system according to an embodiment. FIG. 2C illustrates the connection pin 6 shown in FIG. 2B seen from the other end.

The connection pin 6 comprises a first notch 10 having its free end in a first end of the connection pin 6. The connection pin 6 comprises a second notch 10′ (indicated by a dashed line) having its free end in the opposite end of the connection pin 6.

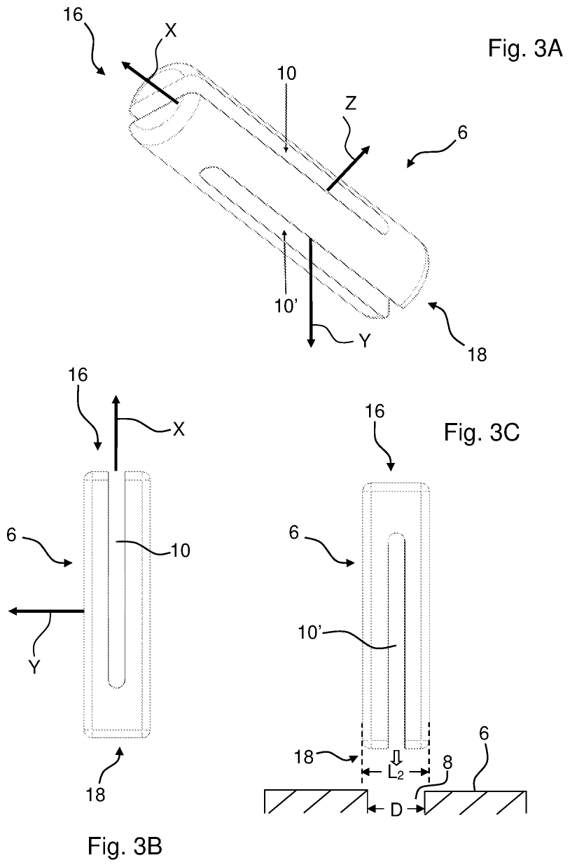

FIG. 3A illustrates a perspective view of connection pin 6 of a construction system according to an embodiment. The connection pin 6 comprises a first notch 10 having its free end in a first end 16 of the connection pin 6. The connection pin 6 comprises a second notch 10′ having its free end in the opposite end 18 of the connection pin 6.

The first notch 10 is basically plate-shaped and extends along the longitudinal axis X and a first lateral axis Z of the connection pin 6.

The second notch 10′ is basically plate-shaped and extends along the longitudinal axis X and a second lateral axis Y of the connection pin 6. The three axes X, Y, Z extend perpendicular to each other and constitute a Cartesian coordinate system.

FIG. 3B illustrates a side view of the connection pin 6 shown in FIG. 3A. The connection pin 6 comprises a first notch 10 extending along the longitudinal axis X and the second lateral axis Z of the connection pin 6. The open end of the notch 10 is provided in the first end 16 of the connection pin 6, while the closed end of the notch 10 is provided in the opposite end 18 of the connection pin 6.

FIG. 3C illustrates the connection pin 6 shown in FIG. 3A and FIG. 3B arranged in a position from which the connection pin 6 is arranged to be inserted into a cylindrical hole 8 of a building block 4. The connection pin 6 comprises a notch 10′ having its free end provided in the end 18 of the connection pin 6, while a closed portion is provided in the opposite end 16 of the connection pin 6. The width L₂ of the end 18 of the connection pin 6 that is placed close to the hole 8 is larger than the width D of the hole 8. When the distal portion of the connection pin is compressed, however, the width L₂ of the end 18 of the connection pin 6 that is placed close to the hole 8 is reduced to such an extent that the connection pin 6 can be inserted into the hole 8.

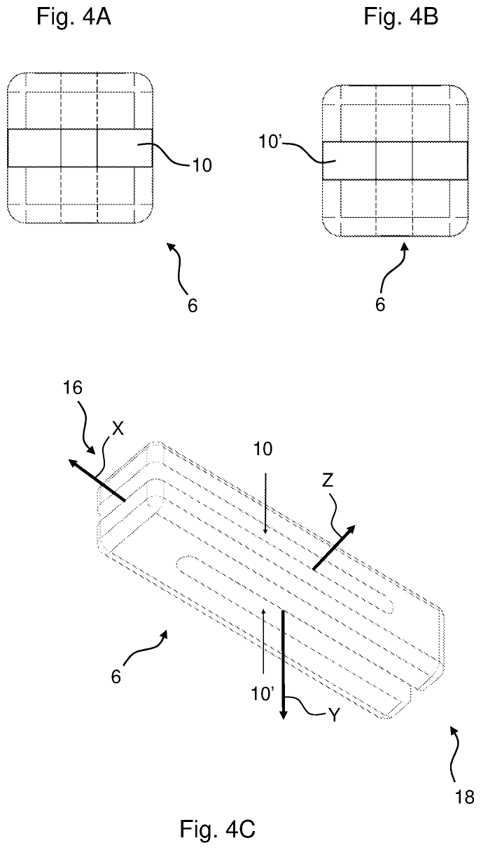

FIG. 4A illustrates an end view of a connection pin 6 of a construction system according to an embodiment. The connection pin 6 comprises a notch 10 having an open end. The connection pin 6 is seen from the end, in which the notch 10 is open.

FIG. 4B illustrates another end view (seen from the opposite end) of the connection pin 6 shown in FIG. 4A. The connection pin 6 comprises a notch 10′ having an open end. The connection pin 6 is seen from the end, in which the notch 10′ is open.

FIG. 4C illustrates a perspective view of a connection pin 6 shown in FIG. 4A and FIG. 4B. The connection pin 6 has a basically box-shaped geometry.

The connection pin 6 comprises a first notch 10 having its free end in a first end 16 of the connection pin 6. The connection pin 6 comprises a second notch 10′ having its free end in the opposite end 18 of the connection pin 6.

The first notch 10 is basically plate-shaped and extends along the longitudinal axis X and a first lateral axis Z of the connection pin 6.

The second notch 10′ is basically plate-shaped and extends along the longitudinal axis X and a second lateral axis Y of the connection pin 6. The three axes X, Y, Z extend perpendicular to each other and constitute a Cartesian coordinate system.

It should be noted that the connection pin 6 should be inserted into a hole having a basically box-shaped geometry.

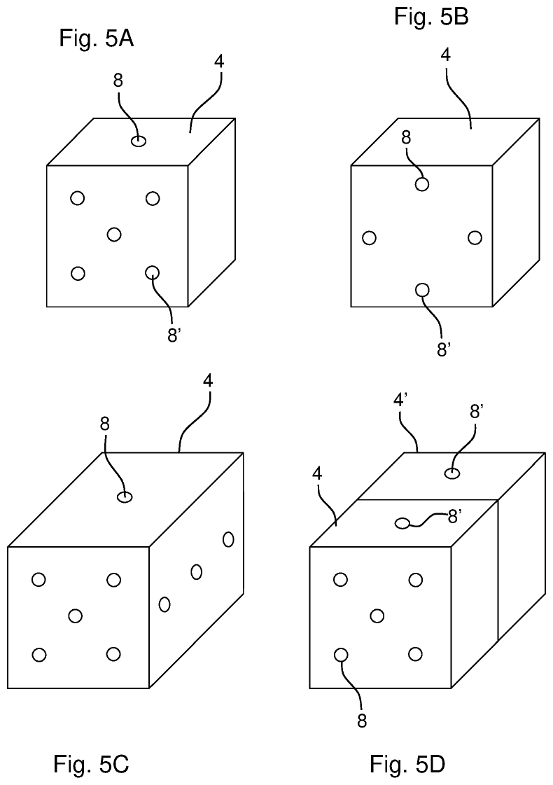

FIG. 5A illustrates a building block 4 of a construction system according to an embodiment. The building block 4 is box-shaped and comprises a square cross section. Five holes 8′ are provided in the front side of the building block 4. A single hole 8 is provided in the top side of the building block 4.

FIG. 5B illustrates another building block 4 of a construction system according to an embodiment. The building block 4 is box-shaped and comprises a square cross section. Four holes 8, 8′ are provided in the front side of the building block 4.

FIG. 5C illustrates a further building block 4 of a construction system according to an embodiment. The building block 4 is box-shaped and comprises two square surfaces and four rectangular surfaces. Five holes 8 are provided in the front side of the building block 4. A single hole 8 is provided in the top side of the building block 4. Three holes 8 are provided in the right side surface of the building block 4.

FIG. 5D illustrates two building blocks 4, 4′ of a construction system according to an embodiment. The building blocks 4, 4′ are box-shaped and attached to each other by using one or more connection pins according to an embodiment (like that shown in and explained with reference to FIG. 1A).

Five holes 8 are provided in the front side of the first building block 4. A single hole 8′ is provided in the top side of the first building block 4. A single hole 8′ is provided in the top side of second building block 4′.

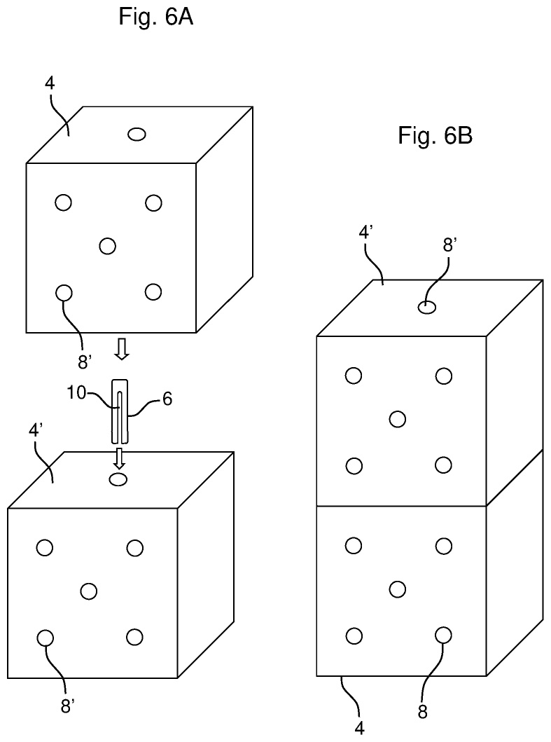

FIG. 6A illustrates two building blocks 4, 4′ of a construction system according to an embodiment being attached to each other by a connection pin 6 according to an embodiment. The building blocks 4, 4′ are provided with holes 8′.

A connection pin 6 provided with a notch 10 having its open end facing the lowermost building block 4′ is arranged in a position in which the connection pin 6 can be inserted into a corresponding hole provided in the top side of the lowermost building block 4′. Moreover, the topmost building block 4 comprises a hole (not shown) designed to receive the connection pin 6 so that the first building block and the second building block can be detachably attached to each other.

FIG. 6B illustrates the two building blocks 4,4 shown in FIG. 6A in an assembled configuration.

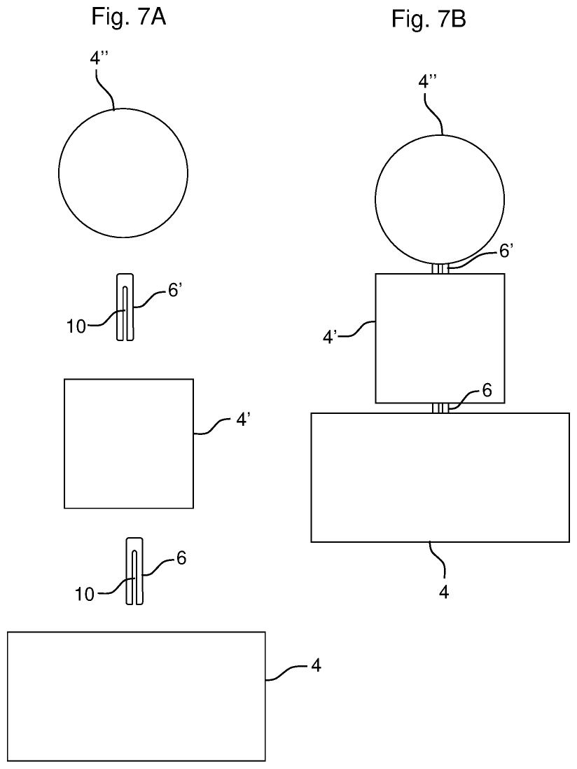

FIG. 7A illustrates three building blocks 4, 4′, 4″ of a construction system according to an embodiment being attached to each other by connection pins 6, 6′ according to an embodiment.

The uppermost building block 4″ is spherical and comprises a hole (not shown) provided in its lower portion.

The lowermost building block 4 is box-shaped and comprises a hole (not shown) provided in its topmost surface.

A box-shaped building block 4′ is arranged between the topmost building block 4″ and the lowermost building block 4.

FIG. 7B illustrates the three building blocks 4, 4′, 4″ shown in FIG. 7A in an assembled configuration in which the first connection pin 6 connects the first building block 4 and the second building block 4′ and in which the second connection pin 6′ connects the third building block 4″ and the second building block 4′.

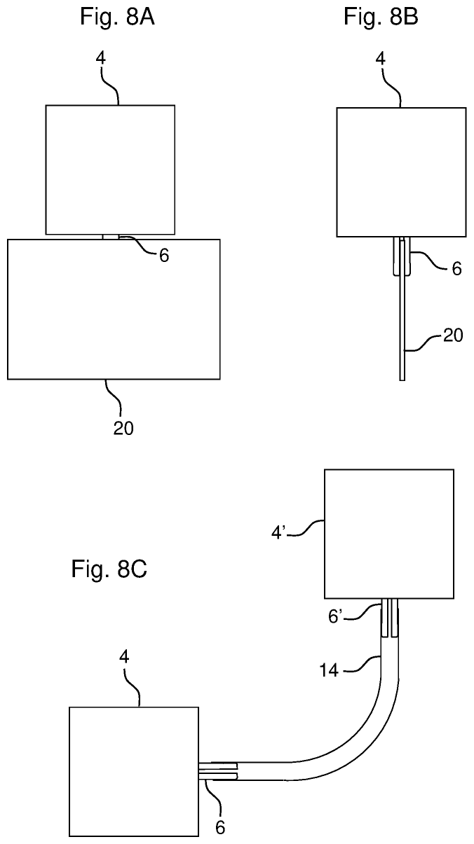

FIG. 8A illustrates two building elements (a box-shaped building block 4 and a plate 20) of a construction system according to an embodiment in a configuration in which the building elements 4, 20 have been attached to each other by a connection pin 6 according to an embodiment.

FIG. 8B illustrates a different view of the construction system shown in FIG. 8A. It can be seen that the plate 20 is attached to the free portion of the notch of the connection pin 6. The other end of the connection pin 6 has been detachably attached to a hole (not shown) in the lowermost portion of the building block 4.

FIG. 8C illustrates two building blocks 4, 4′ of a construction system according to an embodiment in a configuration in which the building blocks 4, 4′ have been attached to a hose 14 by connection pins 6, 6′ according to an embodiment. The hose 14 is provided with holes arranged and configured to receive the connection pins 6, 6′.

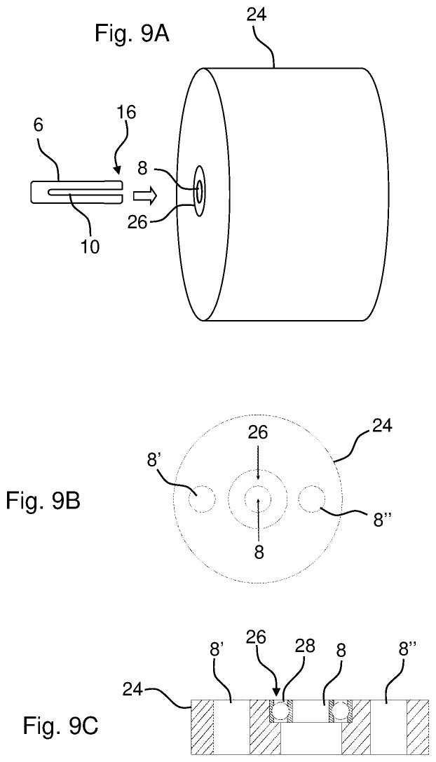

FIG. 9A illustrates a side view of a connection pin 6 being inserted into a building element 24 of a construction system according to an embodiment. The connection pin 6 comprises a notch 10 extending along the longitudinal axis of the connection pin 6. The free end of the notch 10 is arranged in the distal end 16 of the connection pin 6, which is placed close to a hole 8 provided in the building element 24. The building element is formed as a wheel having a cylindrical body portion.

The building element 24 comprises a centrally arranged ball bearing 26.

FIG. 9B illustrates a top view of building element 24 according to an embodiment comprising a ball bearing 26. FIG. 9C illustrates a cross-sectional view of the building element shown in FIG. 9B.

The building element 24 comprises three holes 8, 8′, 8″. The central hole 8 is arranged between the two lateral holes 8′, 8″.

It can be seen that the ball bearing 26 comprises balls 28 rotatably arranged in a bearing housing. Accordingly, a connection pin being inserted into the hole 8 surrounded by the ball bearing 26 is able to rotate relative to the building element 24.

### LIST OF REFERENCE NUMERALS

2 Construction system
4, 4′, 4″ Building block
6, 6′ Connection pin
8, 8′ Hole
10, 10′ Notch
12 Bottom portion
14 Hose
16 First end
18 Second end
20 Plate
24 Wheel
26 Ball bearing
28 Ball
L₁, L₂ Width
L₃, L₄ Width
D Width
D₂ Depth
X, Y, Z Axis

What is claimed is:

1. A construction system comprising:
a) at least two building elements provided with one or more cylindrical holes; and
b) one or more connection pins having a first end, a second end and a longitudinal axis, wherein the connection pins are configured to be detachably inserted into the cylindrical holes and hereby connect two of the building elements, wherein the connection pins are provided with a first notch extending along the longitudinal axis and a second notch extending along the longitudinal axis, wherein the first notch extends from the first end to a first position between the first end and the second end, wherein the second notch extends from the second end to a second position between the first end and the second end,
wherein a width of each of the connection pins is larger than a width of each of the cylindrical holes,
wherein each of the connection pins has a cylindrical outer surface with:
a) the width of each of the connection pins being 2-10% larger than the width of each of the cylindrical holes;
b) the first notch and the second notch being plate-shaped and extending perpendicular to each other; and
c) a depth of the first notch, the second notch or both the first notch and the second notch being greater than two thirds of a length of each of the connection pins.

2. The construction system according to claim 1, wherein a depth of one of the cylindrical holes corresponds to half the length of one of the connection pins.

3. The construction system according to claim 1, wherein at least one of the building elements is box-shaped.

4. The construction system according to claim 1, wherein at least one of the building elements is spherical.

5. The construction system according to claim 1, wherein at least one of the building elements is cylindrical.

6. The construction system according to claim 1, wherein at least one building element is shaped as a hose.

7. The construction system according to claim 1, further comprising a plate designed to be detachably inserted into the first notch or the second notch of one of the connection pins.

8. The construction system according to claim 1, further comprising at least one extension pin that is longer than the connection pins, wherein end portions of the extension pin correspond to end portions of one of the connection pins.

9. The construction system according to claim 1, wherein at least one of the building elements is a wheel comprising a rotatably mounted joint configured to receive an end portion of one of the connection pins.

10. The construction system according to claim 1, wherein the connection pins are made of metal.

11. The construction system according to claim 1, wherein the building elements are made of wood.

12. A method for building a construction system comprising:
a) at least two building elements provided with one or more cylindrical holes; and
b) one or more connection pins having a first end, a second end and a longitudinal axis, wherein the connection pins are configured to be detachably inserted into the cylindrical holes and hereby connect two adjacent building elements, wherein the connection pins are provided with a first notch extending along the longitudinal axis and a second notch extending along the longitudinal axis, wherein the first notch extends from the first end to a first position between the first end and the second end, wherein the second notch extends from the second end to a second position between the first end and the second end,
wherein the method comprises the steps of:
inserting the first end of one of the connection pins into the cylindrical hole of a first building element of the at least two building elements; and
inserting the second end of the one connection pin into the cylindrical hole of a second building element of the at least two building elements, thereby detachably attaching the first building element and the second building element, wherein a width of each of the connection pins is larger than a width of each of the cylindrical holes,
wherein each of the connection pins has a cylindrical outer surface with:
a) the width of each of the connection pins being 2-10% larger than the width of each of the cylindrical holes;
b) the first notch and the second notch being plate-shaped and extending perpendicular to each other; and
c) a depth of the first notch, the second notch or both the first notch and the second notch being greater than two thirds of a length of each of the connection pins.

13. The method according to claim 12, wherein a depth of one of the cylindrical holes corresponds to half the length of one of the connection pins.

14. The method according to claim 12, wherein at least one of the building elements is box-shaped.

15. The method according to claim 12, wherein at least one of the building elements is spherical.

16. The method according to claim 12, wherein at least one of the building elements is cylindrical.

17. The method according to claim 12, wherein at least one of the building elements is shaped as a hose.

18. The method according to claim 12, further comprising a plate designed to be detachably inserted into the first notch or the second notch of one of the connection pins.

19. The method according to claim 12, further comprising at least one extension pin that is longer than the connection pins, wherein end portions of the extension pin correspond to end portions of one of the connection pins.

20. The method according to claim 12, wherein at least one of the building elements is a wheel comprising a rotatably mounted joint configured to receive an end portion of one of the connection pins.
